(19) United States
(12) Patent Application Publication
(10) Pub. No.: US 2008/0003544 A1
(43) Pub. Date: Jan. 3, 2008

(54) MOTORCYCLE BURNOUT PLATFORM

(76) Inventors: Roy Handel, Cornwallville, NY (US); Dale Handel, Cornwallville, NY (US)

Correspondence Address: WALTER J. TENCZA JR., 100 Menlo Park, Suite 210, Edison, NJ, 08837, US

(21) Appl. No.: 11/309,063

(22) Filed: Jun. 15, 2006

(51) Int. Cl. G09B 19/16

(52) U.S. Cl. 434/61

(57) ABSTRACT

An apparatus is provided including means for securing a motorcycle in a substantially stationary position, while a rear motorcycle wheel of the motorcycle is spinning. The apparatus also includes means for obtaining an imprint from a rear tire of the rear motorcycle wheel due to the spinning of the rear motorcycle wheel while the motorcycle is in the substantially stationary position. The apparatus may also include a stage apparatus including a floor and a lift device for raising or lowering the floor and thereby raising or lowering the motorcycle.

### FIELD OF THE INVENTION

This invention relates to methods and apparatus concerning devices for performing motorcycle stunts, such as “burnouts”.

### BACKGROUND OF THE INVENTION

The number of motorcycle enthusiasts has increased greatly over the years and continues to do so. Most venues that are aimed to attract motorcyclists hold events that give bikers an opportunity to display and admire each other's bikes as well as show-off their abilities to perform certain stunts.

The most popular stunt is called a “burnout”. This stunt typically is comprised of engaging the rear drive wheel and the front wheel brake at the same time. With the front wheel brake engaged, the rear tire spins, heats up and eventually degrades.

Burnouts are a well-known aspect of a variety of types of racing. Motorcycle burnouts are performed in order to heat the drive wheel tries and soften the rubber of the tires for improved frictional engagement of the racing surface. Burnouts add to the anticipation and drama of a race and have become a part of American popular culture.

Although engaging the front wheel brake prevents a complete forward motion of the bike, the spinning rear tire causes the rear of the bike to pivot in an arc about the front wheel, the extent of which is contained only by the ability of the biker performing the stunt.

In order to limit the risks to spectators and property, many venues, which are frequented by motorcyclists, have constructed something called “burnout pits”. This is an area that is designated specifically for performing burnouts. It is generally in a separate area and is fenced off in order to offer protection to spectators.

Various devices for performing a burnout are known. U.S. patent application no. US2004/0072601 A1 to Burton discloses a portable display platform 10 having a textured surface section 20 on a floor surface 18 on which a burnout is performed. (Burton, pg. 2, col. 1, paragraphs 20-22). The textured surface section 20 is capable is frictionally degrading a rear wheel tire of a motorcycle. (Burton, pg. 2, paragraph 20). A front wheel tire of a motorcycle is secured by parallel bars 28 and 28′. (Burton, pg. 2, col. 2, paragraph 24). Rear jacks 60 and jack 62 are provided for stabilizing the platform during performance of a stunt.

Teresi, U.S. Pat. No. 6,123,547 discloses a flap 72 which can be raised to prevent forward progress of a motorcycle during a burnout. (Teresi, col. 6, Ins. 23-38). The burnout is conducted in a burnout area 70 on a platform 28. (Teresi, FIG. 1, col. 4, Ins. 35-45, col. 6, Ins. 23-38).

### SUMMARY OF THE INVENTION

In one embodiment of the present invention an apparatus is provided comprising means for securing a motorcycle in a substantially stationary position, while a rear motorcycle wheel of the motorcycle is spinning. The apparatus also includes means for obtaining an imprint from a rear tire of the rear motorcycle wheel due to the spinning of the rear motorcycle wheel. The apparatus may also include means for retaining the means for obtaining an imprint. The means for retaining may be configured to permit the means for obtaining an imprint to be easily inserted into and removed from the means for retaining. When the means for obtaining an imprint is inserted into the means for retaining, the means for retaining keeps the means for obtaining an imprint in a substantially stationary position while the rear motorcycle wheel is spinning.

The means for securing the motorcycle may include a front wheel receiving device and a rear wheel receiving device. The rear wheel receiving device may include an adjustable member, so that the means for securing can secure motorcycles of different sizes. The means for securing the motorcycle may include first and second posts, and a floor to which the first and second posts are fixed.

One embodiment of the present invention may also include a stage apparatus including a floor and a lift device. The lift device can raise or lower the floor. The means for securing the motorcycle may be fixed to the floor.

The means for obtaining the imprint may include a flat board. The means for retaining the means for obtaining the imprint may include two spaced parallel members, which may be fixed to a surface of the floor and an adjustable stopper device.

One embodiment of the present invention includes a method comprising securing a motorcycle in a substantially stationary position, while a rear motorcycle wheel of the motorcycle is spinning, and obtaining an imprint from a rear tire of the rear motorcycle wheel due to the spinning of the rear motorcycle wheel. The method may also include fixing the motorcycle to a floor, raising or lowering the floor, and thereby raising or lowering the motorcycle.

### BRIEF DESCRIPTION OF THE DRAWINGS

FIG. 1 shows an isometric perspective view of various components of an embodiment of the present invention;

FIG. 2 shows an isometric perspective view of the components of FIG. 1 with respect to a top surface and further shows a simplistic diagram of a motorcycle; and

FIG. 3 shows an isometric perspective view of the components of FIG. 1 and a stage apparatus.

### DETAILED DESCRIPTION OF THE DRAWINGS

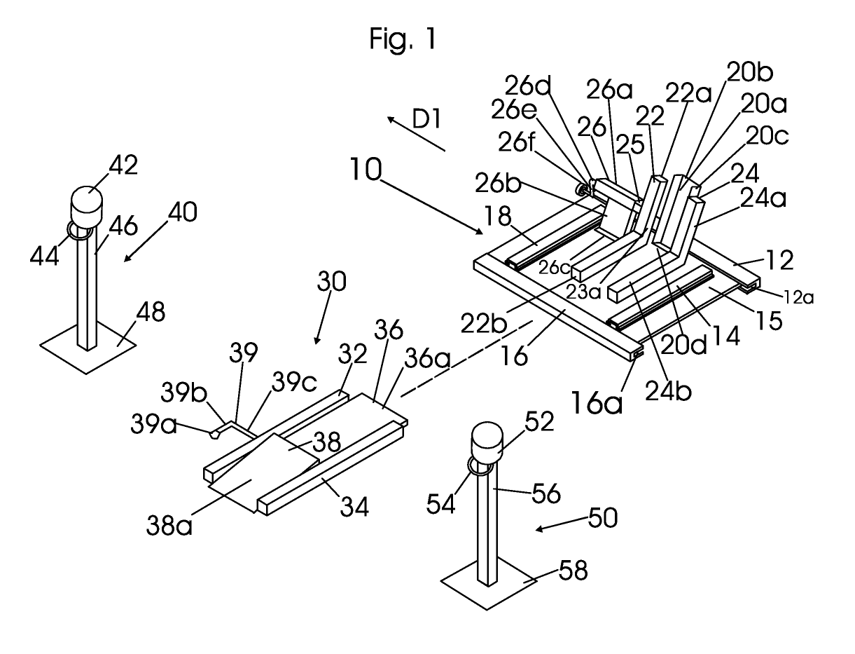

FIG. 1 shows an isometric perspective view of various components of an embodiment of the present invention. FIG. 1 shows device 10, 30, 40, and 50.

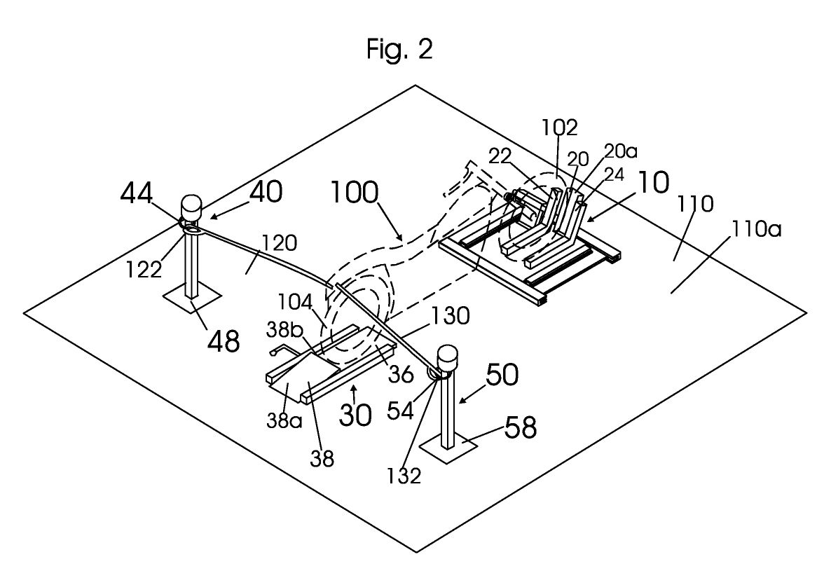

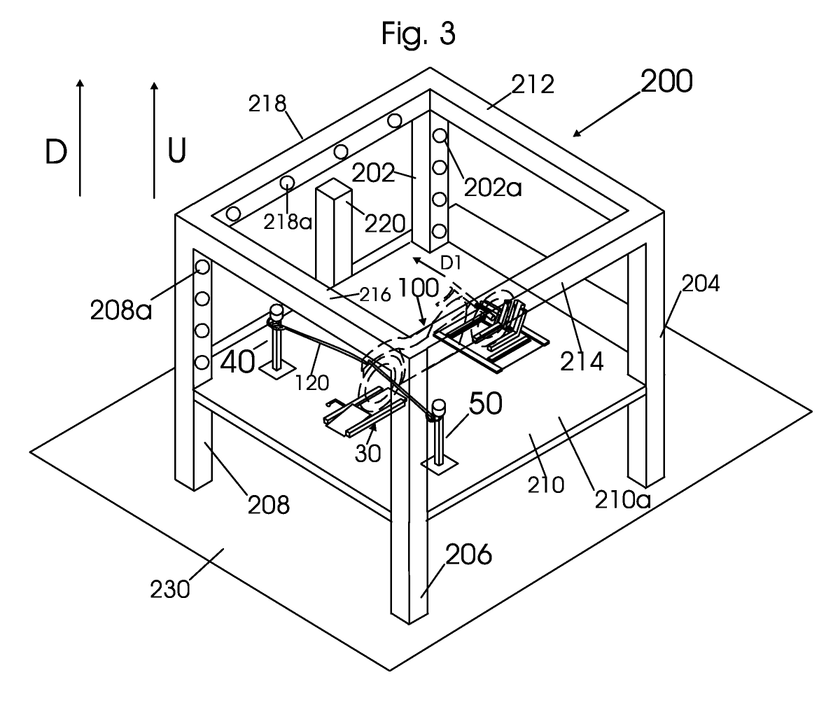

Device 10, is comprised of members 12, 14, 16, and 18. Members 12, 14, 16, and 18 may be metal rails, such as steel or iron rails. The members 12 and 16 are typically fixed to a floor, such as floor or base 110 or floor or base 210, shown in FIGS. 2 and 3, respectively. Device 10 is also comprised of members 20, 22, and 24, and devices 25 and 26. Device 26 is comprised of members 26a, 26b, 26c, 26d, and 26e and handle 26f. Device 10 may be considered to be a front wheel receiving device. Device 10 is also comprised of base 15. The members 14 and 18, which are typically metal strips, are fixed to the base 15. The members 14 and 18 provide stability to the base 15. The base 15 slides in slots 12a and 16a of the members 12 and 16. The members 20, and 24 are also fixed to the base 15. Member 22 is connected to device 26. Device 26 includes member 26b, which is fixed to base 15. Device 26 includes movable member 25, which slides in member 26a to move member 22 with respect to base 15. Member 22 is set at a position with respect to base 15 by the device 26 and the handle 26f.

Pushing the base 15 in the direction D1 causes the base 15 to slide in the slots 12a and 16a in the members 12 and 16 in the direction D1. When the base 15 slides in the direction D1, the members 14, 18, 20, 22, and 24, and device 26 also slide in the direction D1. In this manner the members 14, 18, 20, 22, and 24 can be slid out of the way so that a motorcycle, such as 100 in FIG. 2 can be driven forward after a burnout has been completed. Instead of manually pushing the base 15 or one or more of the attached members 14, 18, 20, 22, and 24, a motor or hydraulic device, not shown, can be used to cause the base 15, members 14, 18, 20, 22, and 24 to slide in the direction D1.

Member 22 is comprised of portion 22b and portion 22a. Portion 22a is fixed at an angle of one hundred and twenty degrees with respect to portion 22b. Portions 22a and 22b are typically connected and are typically one piece. Member 24 may be identical to member 22 and may be comprised of portions 24b and 24a. Portion 24a may also be fixed at an angle of about one hundred and twenty degrees with respect to portion 24b. Portions 24a and 24b are typically connected and are typically one piece. Members 22 and 24 may be metal rectangular bars.

Member 22 may have an inner side 23a to which is attached a non abrasive material, such as a carpet material, which is used so that a motorcycle wheel is not damaged or scratched. Similarly, member 24 may have an inner side facing the inner side 23a, to which is attached a non abrasive material such as a carpet material, which is used so that a motorcycle wheel is not damaged or scratched.

The member or channel iron 20 is typically not attached at all to members 22 or 24. The member or channel iron 20 is typically positioned flush with said members 22 and 24 and between members 22 and 24.

The handle 26f can be turned to move member 22 closer to member 24, and to thereby tighten and hold a motorcycle front tire, such as front tire 102 in FIG. 2, between members 22 and 24. In the embodiment of FIG. 1 member 22 can be moved with respect to base 15, while member 24 is fixed to the base 15.

Device 30 is comprised of members 32 and 34, which may be hollow metal bars. Device 30 is also comprised of stopper device 38. Device 30 may be considered to be a means for retaining. Located between members 32 and 34 is a means 36 for obtaining an imprint from a rear wheel tire. The means 36 in this case is a flat board, which may be made of wood. Stopper device 38 may be a metal ramp, which can be moved forward and backward to accommodate different size motorcycle wheels for correct placement of a rear motorcycle wheel on the means for obtaining an imprint or flat board 36. To accomplish this, there are holes positioned on members 34 and 32 and holes in stopper device 38 so that the stopper device 38 can be moved either forward or backward and a pin such as 39 or 39c can be placed through member 34 and lined up with a hole in the stopper device 38 to secure said stopper device 38. Device 39 may be comprised of a handle 39a, and portions 39b and 39b. Device 30 may be considered to be a rear wheel receiving device, as well as a means for retaining the means for obtaining an imprint 36.

Device 40 may include a top or cap 42, a ring 44, a post 46, and a base 48, all of which may be comprised of a strong rigid metal material. Cap 42 is fixed to post 46, which is fixed to base 48. Ring 44 is fixed to cap 42 and/or post 46. Base 48 is typically fixed, substantially perpendicular to a floor, such as floor 110 shown in FIG. 2. Device 50 may be identical to device 40, and may include a top or cap 52, a ring 54, a post 56, and a base 58. Device 50 may also be fixed to a floor, such as floor 110.

FIG. 2 shows an isometric perspective view of the components of FIG. 1 with respect to a top surface 110a of a base or floor 110 and further shows a simplistic diagram of a motorcycle 100 in dashed lines. In FIG. 2, a rear portion of the motorcycle 100 is tied or otherwise attached to a first end of cords 120 and 130. Opposite ends 122 and 132 of the cords 120 and 130, are attached to rings 44 and 54, respectively. The bases 48 and 58 of the devices 40 and 50, respectively, are fixed to the surface 110a of the base or floor 110. The cords 120 and 130 can be chains, ropes, or any other fastening mechanism. The cords 120 and 130 should be taut to prevent the motorcycle 100 from moving substantially from the position shown in FIG. 2, after the motorcycle 100 has been turned on and is in a drive state, with the rear wheel 104 spinning.

In FIG. 2, a rear tire 104 of the motorcycle 100 is on top of the board or means for obtaining an imprint 36. The rear tire 104 does not make contact with the top surface 38a of the stopper device 38, but may make contact with an edge 38b of the stopper device 38. The front tire 102 of the motorcycle 100 is located between the members 22 and 24 of the front wheel receiving device 10 and makes contact with a flat plate portion 20a of the member 20.

FIG. 3 shows an isometric perspective view of the components of FIG. 1, the motorcycle 100, and a stage apparatus 200. The stage apparatus 200 includes columns 202, 204, 206, and 208, and members or beams 212, 214, 216, and 218. The stage apparatus 200 also includes a stage floor 210 having a surface 210a. The devices 10, 30, 40, and 50 may be fixed to the surface 210a of the stage floor 210 and/or generally to the stage floor 210. The stage apparatus 200 may include a lift device, such as a hydraulic lift device 220 for lifting the stage floor 210 upwards in the direction U or downwards in the direction D, while maintaining the stage floor 210 substantially parallel to the beams 212, 214, 216, and 218. The stage floor 210 can be raised in the direction U or lowered in the direction D during or just prior to an “aerial burnout” performance.

The beams or columns may have attached thereto stage lights. For example, beam 218 may have attached thereto a plurality of stage lights such as including stage light 218a, column 208 may have attached thereto a plurality of stage lights, such as including stage light 208a, and column 202 may have attached thereto a plurality of stage lights such as including stage light 202a.

The combination of the stage apparatus 200 and devices 10, 30, 40, and 50, can be modified to be mobile so that an individual can truck it to another site or establishment. For example, the stage apparatus 200 can be placed on a flat bed trailer with wheels, not shown. Removable ramps can be provided to allow a motorcycle to embark or disembark.

The lift device 220 may be used to raise the floor 210 in the direction U to its highest level prior to an aerial motorcycle burnout performance, so that during such a performance spectators can easily see the motorcycle 100. The lift device 220 may thereafter be used to lower the floor 210 in the direction D, to its lowest level, so that the motorcycle can be driven off of the floor 210 and onto a ground surface, such as ground surface 230 shown in FIG. 3. Alternatively, the lift device 220 may lower the floor 210 to a certain level above the ground surface 230 and then ramps may be used to allow a motorcycle to drive up and drive off of the floor 210.

Lights and ornamental indicia, such as names of sponsors or companies, may be placed on the beams 212, 214, 216, and 218 or on the columns 202, 204, 206, and 208. The beams 212, 214, 216, and 218, and columns 202, 204, 206, and 208 can also accommodate speakers for music.

In operation, the floor 210 is lowered by the lift device 220 so that the floor 210 is substantially on the ground surface 230. Prior to a motorcycle pulling onto floor or base 210, a board or means for obtaining an imprint (typically wood but can be any material on which the imprint of the burn-out will appear) is placed between the two parallel tubes or members 32 and 34 of the rear wheel receiving device 30 based on the length of the motorcycle, such as 100, and the approximate place where the rear tire, such as tire 104 would be. The stopper device 38 of the rear wheel receiving device 30 is placed directly behind the board or means for obtaining an imprint 36 and secured to the parallel tubes or members 32 and 34 (to prevent the board or means for obtaining an imprint 36 from flying out) by pins passing through each of members 32 and 34, such as by pin or member or portion 39c passing through members 32 and 34.

A motorcycle 100 next pulls up onto the floor 210 and drives onto the surface 36a on the board or means for obtaining an imprint 36. The motorcycle 100 pulls up as far as the front wheel receiving device 10 and stops in front of the channel iron or member 20 provided on the front wheel receiving device 10. The front tire 102 typically comes in contact with the plate 20a of the member or channel iron 20.

The front wheel 102 of the motorcycle 100 is secured by securing means, which are attached to the front wheel receiving device 10. The channel iron or member 20 on the front of the front wheel receiving device 10 prevents the motorcycle 100 from moving forward during execution of a bunt-out. The rear tire 104 is secured to the posts or devices 40 and 50, by securing means such as cords 120 and 130. Each of posts or device 40 and 50 may have a height of fourteen and one-half inches. Typically anything drastically higher or lower than this height may not allow the rear wheel of motorcycle tire to always say down on the surface 36a of the means 36 to conduct a perfect burnout. A gate on the back of the platform, not shown, typically behind the rear tire 104, is closed and the platform or floor 210 is raised, typically seven feet off of the ground surface 230. The motorcycle 100 executes an aerial burn-out with lights and music. Afterwards, the floor 210 is lowered, and the securing means, previously attached to the rear tire 104 and the front tire 102, are removed from the motorcycle 100. The rear gate is opened. The motorcycle 100 is backed up slightly to remove the front wheel 102 from the front wheel receiving device 10. The front wheel receiving device 10 is moved in the direction D1 (shown in FIG. 1 and FIG. 3), to the side, so that the motorcycle 100 may be driven straight ahead to exit the floor 210 or platform. The motorcycle 100 disembarks and the motorcycle driver is provided with his souvenir board or means for obtaining an imprint 36 having typically a rubber or synthetic rubber motorcycle tire imprint on it.

The cords 120 and 130 may be nylon straps and prevent additional forward motion or any lateral motion. The elevation of the floor 210, in addition to allowing spectators to see the burnout more easily, is also done so that smoke that is created from the burnout, as well as the motorcycle 100, is elevated out of the way and in a controlled, safe direction. The smoke that is typically generated comes from the board or means for generating an imprint 36 that is placed under the rear tire 104, and typically not the rear tire 104, itself. Behind the motorcycle 100 is typically a safety gate and cabling on the sides. The safety gate may be mounted on the posts 206 and 208 and typically would be a split gate and may have a height of forty-two inches. The area surrounding the floor 210 will typically be fenced off so as to prevent spectators from getting too close.

The front wheel receiving device 10 is typically made of steel or some other strong, rigid metal, and is adapted to slide over to the side to allow a motorcycle, such as 100, to exit, in a forward direction after it has performed an aerial burn-out. Note that the burnout is “aerial” in the sense that the floor 210 is raised. The front wheel receiving device 10 includes means to secure the front tire 102 and a channel iron or member 20 on its front end, approximately sixteen inches high, which prevents the front wheel or tire 102 of the motorcycle 100 from moving forward while the burn-out is being performed. An additional safety nylon strap, not shown, is typically used to secure a front motorcycle tire, such as tire 102. The additional safety nylon strap may be placed through the rim of the front motorcycle tire 102 and secured to the slidable base 15 of the front wheel receiving device 10 on both sides of the front wheel or tire 102.

The rear wheel receiving device or device 30 is adapted to receive and to retain a board or means for obtaining an imprint 36 on which the burn-out becomes imbedded. The device 30 includes two tubes or members 32 and 34, which can be made of steel, running parallel to each other and typically welded onto the base or stage floor 210. The board or means for obtaining an imprint 36 is placed within the members or tubes 32 and 34. Each of tubes or members 32 and 34 has holes running along it length so that a motorcycle's length is irrelevant because the placement of the board or means for obtaining an imprint 36 can he adjusted to accommodate a rear tire, such as 104, by sliding the board or means for obtaining an imprint 36 to the appropriate spot for the placement of the rear tire, such as 104 and by securing with pins, such as pin portion 39c. The back end of the board or means for obtaining an imprint 36 is secured with a stopper device 38 placed between the width of the two parallel tubes 32 and 34. The stopper device 38 also has a hole on each end. The stopper device 38 is secured by placing pins, such as 39 in the holes of the parallel tubes 32 and 34 and through said holes in the stopper device 38. This stopper device 38 prevents the wood from board or means for obtaining an imprint 36 from flying back when the motorcycle rear tire 104 is spinning to perform the burnout.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

What is claimed is:

1. An apparatus comprising:
means for securing a motorcycle in a substantially stationary position, while a rear motorcycle wheel of the motorcycle is spinning;
means for obtaining an imprint from a rear tire of the rear motorcycle wheel due to the spinning of the rear motorcycle wheel while the motorcycle is in the substantially stationary position;
means for retaining the means for obtaining an imprint;
wherein the means for retaining is configured to permit the means for obtaining an imprint to be easily inserted into and removed from the means for retaining; and
wherein when the means for obtaining an imprint is inserted into the means for retaining, the means for retaining keeps the means for obtaining an imprint in a substantially stationary position while the rear motorcycle wheel is spinning.

2. The apparatus of claim 1 wherein
the means for retaining is comprised of two parallel members, and a stopper device located between the two parallel members.

3. The apparatus of claim 1 wherein
the means for securing the motorcycle include a front wheel receiving device.

4. The apparatus of claim 1 wherein
the means for securing the motorcycle include a rear wheel receiving device.

5. The apparatus of claim 4 wherein
the rear wheel receiving device includes an adjustable member, so that the means for securing can secure motorcycles of different sizes.

6. The apparatus of claim 1 wherein
the means for securing the motorcycle includes first and second posts, and a floor to which the first and second posts are fixed.

7. The apparatus of claim 1 further comprising
a stage apparatus including a floor and a lift device;
wherein the lift device can raise or lower the floor; and
and wherein the means for securing is fixed to the floor.

8. The apparatus of claim 1 wherein
the means for obtaining an imprint includes a flat board.

9. The apparatus of claim 7 wherein
the means for obtaining an imprint includes two spaced parallel members, which are fixed to a surface of the floor.

10. The apparatus of claim 9 wherein
the means for obtaining the imprint includes a flat board.

11. A method comprising:
securing a motorcycle in a substantially stationary position, while a rear motorcycle wheel of the motorcycle is spinning;
inserting a first means for obtaining a first imprint into a means for retaining;
obtaining a first imprint on the first means for obtaining the first imprint, wherein the first imprint is obtained from a rear tire of the rear motorcycle wheel due to the spinning of the rear motorcycle wheel while the motorcycle is in the substantially stationary position; and
removing the first means for obtaining the first imprint from the means for retaining after the first imprint has been obtained.

12. The method of claim 111 further comprising
placing a date on the first means for obtaining a first imprint.

13. The method of claim 111 further comprising
inserting a second means for obtaining a second imprint into the means for retaining;
obtaining a second imprint on the second means for obtaining the second imprint, wherein the second imprint is obtained from the rear tire of the rear motorcycle wheel due to the spinning of the rear motorcycle wheel while the motorcycle is in the substantially stationary position; and
removing the second means for obtaining the second imprint from the means for retaining after a second imprint has been obtained.

14. The method of claim 111 wherein
the motorcycle is secured by use of a front wheel receiving device.

15. The method of claim 11 wherein
the motorcycle is secured by use of a rear wheel receiving device.

16. The method of claim 15 wherein
the rear wheel receiving device includes an adjustable member, so that motorcycles of different sizes can be secured.

17. The method of claim 11 wherein
the motorcycle is secured by used of first and second posts, which are fixed to a floor.

18. The method of claim 111 further comprising
fixing the motorcycle to a floor; and
raising or lowering the floor and thereby raising or lowering the motorcycle.

19. The method of claim 111 wherein
the imprint is shown on a flat board.

20. The method of claim 19 further comprising
placing the flat board between two spaced parallel members, which are fixed to a surface of the floor.
